(19) United States
(12) Patent Application Publication
(10) Pub. No.: US 2008/0117890 A1
(43) Pub. Date: May 22, 2008

(54) METHOD AND APPARATUS FOR SHARING NETWORK RESOURCES

(75) Inventor: Hak-goo Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/763,544

(22) Filed: Jun. 15, 2007

(30) Foreign Application Priority Data
Nov. 22, 2006 (KR) 2006-116067

(51) Int. Cl. H04J 3/00

(52) U.S. Cl. 370/345

(57) ABSTRACT

A method of sharing network resources through a wire/wireless interface between a first device and a second device is provided, in which the first device is connected with a wireless broadband network and the second device is not connected with the wireless broadband network. Such a method includes determining an operation mode according to whether the network resource is to be shared; and selectively routing packets transmitted between the network and the second device based on the determined operation mode.

### CROSS-REFERENCE TO RELATED APPLICATIONS

This application claims the all benefits accruing under 35 U.S.C. §119 from Korean Patent Application No. 2006-116067, filed on Nov. 22, 2006, in the Korean Intellectual Property Office, the disclosure of which is incorporated herein by reference.

### BACKGROUND OF THE INVENTION

1. Field of the Invention

The present invention relates to a method and apparatus for sharing network resources, and more particularly, to a method of sharing network resources through a wire/wireless interface between a first device and a second device, in which the first device is connected with a wireless broadband network and the second device is not connected with the wireless broadband network.

2. Related Art

Since wire Internet and wireless Internet have become widely used due to high-speed network, using asymmetric digital service line (ADSL) and cable modems, homes can be easily connected to outside networks, such as the Internet. However, in these services, the Internet can be used only in devices that are connected directly to the network, but not in devices to which the network is not directly connected thereto. As a result, methods of connecting a device that is not connected to a network, such as a user computer, to a device that is connected to a network, such as a portable terminal (e.g., a mobile phone, a personal digital assistant “PDA”, and a notebook PC), are being developed.

FIG. 1 illustrates a conventional method of accessing a network such as the Internet by way of a portable terminal. Referring to FIG. 1, a portable terminal 110 is connected to a network, and can be a mobile phone, a PDA or a notebook PC. A user computer 120 is not connected to the network, but can be connected to the portable terminal 110. Such a user computer 120 can also be a notebook or laptop PC or other computing device. The user can access an outside network, such as the Internet, via the portable terminal 110 by establishing connection with the outside network. Alternatively, the user can access an outside network, such as the Internet, via a host computer 120 by connecting the user computer 120 with the portable terminal 110.

However, when the internet service is used through the user computer 120, the portable terminal 110 cannot use the network resource. As a result, the internet service cannot be used through the portable terminal 110, while the user computer 120 is connected to the portable terminal 110.

A recent technique of sharing the network resource is to install and use an IP sharer installed between a device that is connected to a network and a device that is not connected to the network, respectively, so that the outside network, such as the Internet can be used in both devices. However, a user needs to additionally pay for the IP sharer and then install the IP sharer in those devices.

Moreover, when a network resource is used by connecting a device that is not connected to a network with a device that is connected to a network, only one of these devices can use the network resource. Furthermore, in order for both devices to use the network resource, yet additional and costly hardware must be installed in both devices.

### SUMMARY OF THE INVENTION

Several aspects and example embodiments of the present invention provide a method and an apparatus for sharing network resources using a first device that is directly connected to a network through software and a second device that is not connected to the network.

Additional aspects and/or advantages of the invention will be set forth in part in the description which follows and, in part, will be obvious from the description, or may be learned by practice of the invention.

In accordance with an example embodiment of the present invention, a method of sharing network resources through a wire/wireless interface between a first device and a second device is provided, in which the first device is connected with a wireless broadband network and the second device is not connected with the wireless broadband network. Such a method comprises determining an operation mode according to whether the network resource is to be shared; and selectively routing packets transmitted between the network and the second device based on the determined operation mode.

According to an aspect of the present invention, the routing may be performed using a Time Division Multiplexer (TDM), when the operation mode is in a network resource sharing mode for sharing the network resource between the first device and the second device.

According to another aspect of the present invention, the routing may be performed based on an IP address and a port number of a header inserted into the packets, when the operation mode is in a network resource sharing mode for sharing the network resource between the first device and the second device.

According to another aspect of the present invention, the routing may be continuously performed on the packets, when the operation mode is in a network resource dedicated mode for dedicating the network resource to the second device.

According to an aspect of the present invention, the routing may be performed by predetermined software installed in the first device.

In accordance with another example embodiment of the present invention, an apparatus for sharing a network resource with a device that is not connected to a network, comprises: a mode determination unit which determines an operation mode according to whether the network resource is to be shared; and a transmission control unit which selectively routes packets transmitted between the network and the device that is not connected to the network based on the determined operation mode.

According to an aspect of the present invention, the transmission control unit may route the packets using a Time Division Multiplexer (TDM), when the operation mode is in a network resource sharing mode for sharing the network resource between the first device and the second device.

According to an aspect of the present invention, the transmission control unit may route the packets based on an IP address and a port number of a header inserted into the packets, when the operation mode is in a network resource sharing mode for sharing the network resource between the first device and the second device.

According to an aspect of the present invention, the transmission control unit may continuously route the packets, when the operation mode is in a network resource dedicated mode for dedicating the network resource to the second device.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates a conventional method of accessing an outside network, such as the Internet, by a portable terminal;

FIG. 2 is a conceptual view of a network resource sharing apparatus according to an example embodiment of the present invention;

FIG. 3 is a diagram of a network resource sharing apparatus according to an example embodiment of the present invention;

FIG. 4 is a flow chart illustrating a process of transmitting a packet to a network using a first device according to an example embodiment of the present invention;

FIG. 5 is a diagram illustrating an operation of a transmission control unit of a network resource sharing apparatus according to an example embodiment of the present invention;

FIG. 6 is a diagram illustrating a Time Division Multiplexer (TDM) operation according to an example embodiment of the present invention;

FIG. 7 is a flow chart illustrating a process of transmitting a packet to a network using a first device operable in a network resource sharing mode, according to an example embodiment of the present invention; and

FIG. 8 is a flow chart illustrating a process of receiving a packet from a network using a first device operable in a network resource sharing mode, according to an example embodiment of the present invention.

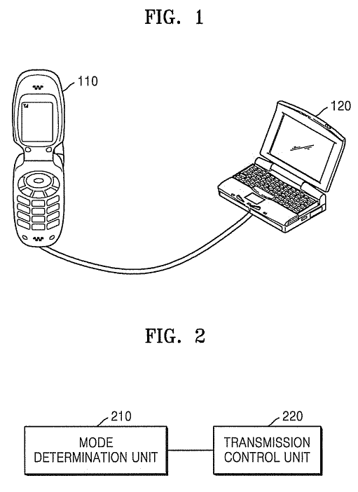

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a conceptual view of a network resource sharing apparatus according to an example embodiment of the present invention. The network resource sharing apparatus can be implemented in software, firmware or hardware, such as, for example, an application specific integrated circuit (ASIC) or printed circuit board (PCB), installed or integrated into a device that shares network resources with another device. For example, such a network resource sharing apparatus, as shown in FIG. 2, may be a software module installed at a device that is connected to a network (i.e., a first device) to enable the first device to operate in one of two operation modes: (1) a dedicated mode for using the network resource only by a device that is not connected to a network (i.e., a second device) but is connected to the first device in which the second device is able to access and use an outside network, such as the Internet, via the first device; and (2) a network resource sharing mode for sharing the network resources between the first device and the second device in which both the first device and the second device are able to access and use the outside network together.

Referring to FIG. 2, the network resource sharing apparatus includes a mode determination unit 210 and a transmission control unit 220.

The mode determination unit 210 determines an operation mode according to whether the network resource is to be shared between a first device that is connected to a network and a second device that is not connected to the network.

The transmission control unit 220 then selectively routes packets transmitted between the network and the second device based on the operation mode determined by the mode determination unit 210.

As previously discussed, the network resource sharing apparatus is operable in two operation modes, a dedicated mode for using the network resource by only a device that is not connected with the network, and a sharing mode for sharing the network resource between first and second devices.

For example, when a user wants to use the Internet in the second device only, a signal selecting a dedicated mode in the first device is inputted, via an input device (not shown), such as a keyboard, and the mode determination unit 210, which receives the inputted signal, determines the operation mode to be the dedicated mode. Similarly, when the user wants to use the internet in both the first and second devices, a signal selecting a sharing mode in the first device is inputted, via an input device, and the mode determination unit 210, which receives the inputted signal, determines the operation mode to be the sharing mode.

In this case, the first device is connected to a wireless broadband network using, for example, HSPDA and WiBro, and the first device and the second device are connected to each other using a wire/wireless interface, such as Bluetooth, wireless USB, wired USB, or IEEE 1394.

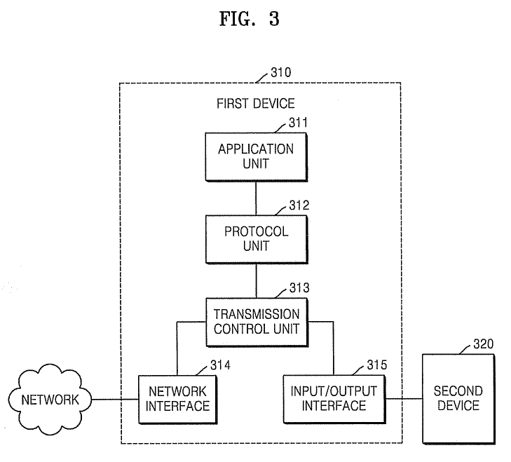

Turning now to FIG. 3, an implementation example of a network resource sharing apparatus according to an example embodiment of the present invention is illustrated. The network resource sharing apparatus can be installed in a first device 310, and can be referred as a “network resource sharing device” connected to a network, such as a wireless broadband network.

Referring to FIG. 3, the first device 310, which can be referred as the network resource sharing device, includes an application unit 311, a protocol unit 312, a transmission control unit 313, a network interface 314, and an input/output interface 315. However, the mode determination unit 210, as shown in FIG. 2, is not shown for the sake of brevity.

The network interface 314 is a connection path between the network and the first device 310, and performs functions that a general network driver performs. In other words, the network interface 314 converts an electrical signal received from the network into a series of data packets to transmit to the transmission control unit 313, and converts each packet received from the transmission control unit 313 into an electrical signal to transmit to the network, such as a wireless broadband network.

The transmission control unit 313 transmits the packet received from the network interface 314 to the protocol unit 312, or the input/output interface 315 based on the operation mode determined by the mode determination unit 210, or transmits a packet received from the protocol unit 312 or the input/output interface 315 to the network interface 314.

The protocol unit 312 performs functions of the transport layer and the network layer of the OSI 7 layer model, for example, a function which TCP/IP performs. In other words, a header on which an IP address and a port number are recorded is inserted into the packet received from the transmission control unit 313 and the packet is transmitted to the application unit 311, and a header on which an IP address and a port number are recorded is inserted into the packet received from the application unit 311 and the packet is transmitted to the transmission control unit 313.

The application unit 311 provides a visual display of data included in the packet received from the protocol unit 312, via a user interface using a text and a graphic for the user to identify, and may be a web browser, for example, internet explorer or Netscape.

The input/output interface 315 transmits the packet received from the transmission control unit 313 to the second device 320 and transmits the packet received from the second device 320 to the transmission control unit 313. As described above, the input/output (IO) interface 315 is a wired/wireless interface such as Bluetooth, wireless USB, wired USB or IEEE 1394.

In addition, although not shown in FIG. 3, an input/output conversion unit for converting an input/output format may be further included between the transmission control unit 313 and the input/output (IO) interface 315. The input/output conversion unit is needed because a bus which transmits the packet in the first device and a bus which is used in the input/output interface 315 are sometimes different. For example, when the bus used in transmitting the packet in the first device is a peripheral component interconnect (PCI) type and the bus supported in the input/output interface 315 is a Universal Serial Bus (USB) type, the format of a packet suitable for the PCI type bus should be converted into a format suitable for the USB type bus.

As such, when the packet that is converted into the format suitable for the USB type bus in the input/output (IO) conversion unit is transmitted to the input/output interface 315, the input/output interface 315 can transmit the received packet to the second device, without an additional conversion process.

The application unit 311, the protocol unit 312, the network interface 314, and the input/output interface 315, as shown in FIG. 3, can be installed in a network device, and can be realized in software, such as a driver, rather than hardware.

In addition, in order to realize the mode determination unit 210 and the transmission control unit 313, predetermined software may be installed in the network device to be operated. In other words, a hardware which has functions of the mode determination unit 210 and the transmission control unit 313 is not inserted in the network resource sharing device 310. Instead, predetermined software is installed and operated and thus the network device functions as the network resource sharing device.

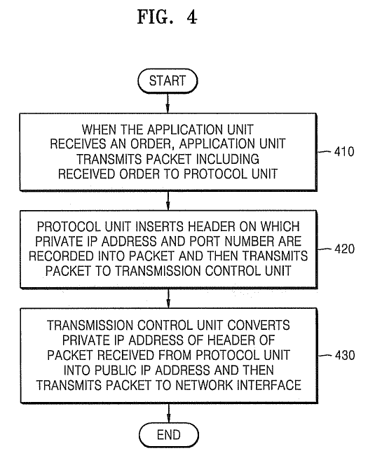

FIG. 4 is a flow chart illustrating a process of transmitting a packet to a network, via a first device, when the first device is connected to the network and a second device is not connected to the first device. The first device 310 is provided with an application unit 311, a protocol unit 312, a transmission control unit 313, a network interface 314 and an input/output (IO) interface 315, as shown in FIG. 3.

In operation 410, when the application unit 311 receives an order, the application unit 311 transmits a packet including the received order to the protocol unit 312.

For example, when a user surfs the web using the application unit 311 and clicks on a moving picture file, the application unit 311 records the order which calls the moving picture file onto a packet and transmits the packet to the protocol unit 312.

In operation 420, the protocol unit 312 inserts a header on which a private IP address and a port number are recorded into the packet, and then transmits the packet to the transmission control unit 313.

For example, when a private IP address is 198.126.10.3, the protocol unit 312 inserts the header on which the private IP address 198.126.10.3 is recorded into a packet received from the application unit 311 and then transmits the packet to the transmission control unit 313.

In operation 430, the transmission control unit 313 converts the private IP address of the header of the packet received from the protocol unit 312 into a public IP address, and then transmits the packet to the network, via the network interface 314.

For example, when the private IP address is 198.126.10.3 and the public IP address used in the network is 221.100.10.1, the transmission control unit 313 converts the private IP address 198.126.10.3 of the header inserted into the packet into the public IP address 221.100.10.1, and records the public IP address again on the header, and then transmits the packet having the header on which the public IP address is recorded to the network, via the network interface 314. When performing this conversion, the transmission control unit 313 separately records the private IP address prior to conversion. The private IP address is used later during converting the public IP address into the private IP address which will be described later.

In operation 440, the network interface 314 transmits the received packet to the network. In this case, the network interface 314 converts a packet received from the transmission control unit 313 into an electrical signal, and transmits the electrical signal to the network.

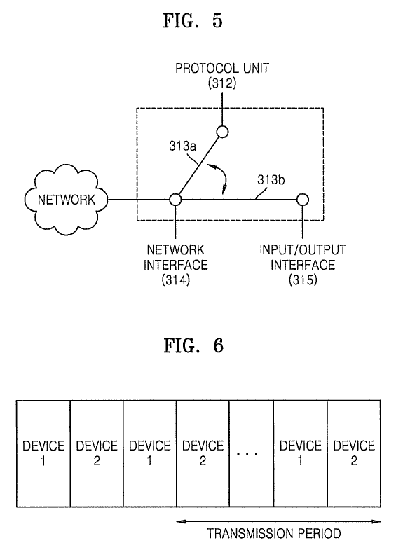

FIG. 5 is a diagram illustrating an operation of a transmission control unit according to an embodiment of the present invention. As shown in FIG. 5, the transmission control unit 313 selects a path through which to route the packet according to the operation mode of the first device 310 (also known as the “network resource sharing device”). In other words, a path through which the packet is routed is selected according to whether an operation mode is a dedicated mode in which the network resource dedicated to the second device is used or a network resource sharing mode in which the network resource is shared between the first device 310 and the second device 320.

When the transmission control unit 313 is a dedicated mode in which the network resource dedicated to the second device is used, the packet is not transmitted to a path 313a interposed between the protocol unit 312 and the network interface 314 and is transmitted only to a path 313b interposed between the network interface 314 and the input/output (IO) interface 315.

In other words, when the packet is received from the network, the network interface 314 transmits the received packet to the transmission control unit 313. Then, the transmission control unit 313 does not transmit the received packet to the protocol unit 312 and continuously transmits the received packet only to the input/output (IO) interface 315. Lastly, the input/output (IO) interface 315 transmits the received packet to the second device 320.

Meanwhile, when the transmission control unit 313 is a network resource sharing mode in which the network resource is shared between the first device 310 and the second device 320, the packet is transmitted using both path 313a interposed between the protocol unit 312 and the network interface 314 and path 313b interposed between the network interface 314 and the input/output (IO) interface 315.

However, both paths are not used at the same time. Instead, both paths are used alternately in different time delay using a time division multiplexer (TDM). Here, in the TDM, data transmission time of one transmission line is divided into fixed time slots to be sequentially distributed so that one transmission line is used by various devices.

FIG. 6 is a diagram illustrating an example time division multiplexer (TDM) operation according to an embodiment of the present invention. Referring to FIG. 6, time is divided into a transmission period and the transmission line is used by a first device 310 (device #1) and a second device 320 (device #2). In other words, during the time when the transmission is allocated to the second device 320 (device #2), the second device 320 (device #2) uses the transmission line, and during the time when the transmission line is allocated to the first device 310 (device #1), the first device 310 (device #1) uses the transmission line. As such, when the transmission line is alternately used, data can be transmitted even if a plurality of devices share a single transmission line.

When the first and second devices (device #1) and (device #2) operate in a network resource sharing mode in which the network resource is shared between the first device 310 and the second device 320, the transmission control unit 313 switches the path 313a interposed between the protocol unit 312 and the network interface 314 and the path 313b interposed between the network interface 314 and the input/output (IO) interface 315 using the TDM. In other words, the first device 310 communicates with the network by transmitting the packet between the protocol unit 312 and the network interface 314 using the path 313a in a fixed time, and the second device 320 communicates with the network by transmitting the packet between the network interface 314 and the input/output interface 315 using the path 313b in a fixed time.

In addition, when the transmission control unit 313 is in a sharing mode in which the network resource is shared by the first device 310 and the second device 320, the packet is routed using the IP address and the port number recorded on the header of the packet.

For example, if the private IP address and the port number recorded on the header of the packet in the first device 310 are 198.126.10.3 and 101, respectively, and if the private IP address and the port number recorded on the header of the packet in the second device 320 are 198.126.10.3 and 202, respectively, the IP address and the port number is recorded as 198.126.10.3.101 and 198.126.10.3.202 in the header of the packet in the first device 310 and the second device 320, respectively.

As such, when the packets having the header on which the IP addresses and the port numbers are recorded are received in the transmission control unit 313 using the TDM, the transmission control unit 313 records the IP address and the port number recorded on each packet, and converts each private IP address and the port number into the public IP address and the port number so as to transmit to the network interface 314.

For example, when the public IP address is 221.100.10.1, 198.126.10.3.101 can be converted into 221.100.10.1.1009 in the packet of the first device 310, and 198.126.10.3.202 can be converted into 221.100.10.1.2017 in the packet of the second device 320. Here, the last four numbers of the public IP address is the port number to be converted. The port number to be converted can be any number in a range of 1 through 65535. The transmission control unit 313 records the IP addresses and the port numbers converted as above on the header of the packet, and then transmits the packet to the network, via the network interface 314.

The network interface 314 converts the packet having the header on which the IP addresses and the port numbers are recorded into an electrical signal, and transmits the signal to the network.

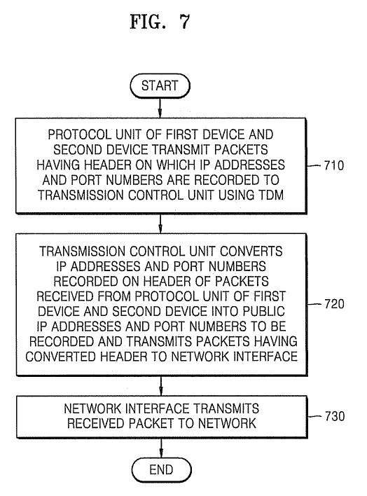

FIG. 7 is a flow chart illustrating a process of transmitting a packet to the network, via a first device operable in a network resource sharing mode, according to an example embodiment of the present invention.

In operation 710, the protocol unit 312 of the first device 310 and the second device 320 transmit the packets having the header on which the IP addresses and the port numbers are recorded to the transmission control unit 313 using the time division multiplexer (TDM).

In operation 720, the transmission control unit 313 converts the IP addresses and the port numbers recorded on the header of the packets received from the protocol unit 312 of the first device 310 and the second device 320 into the public IP addresses and the port numbers to be recorded, and transmits the packets having converted header to the network, via the network interface 314.

In operation 730, the network interface 314 transmits the received packet to the network.

Next, in the network resource sharing mode in which the network resource is shared by the first device 310 and the second device 320, a process of receiving the packet from the network using the first device 310 will be described.

However, the process of receiving the packet will be described assuming that the first device 310 receives the packet in response to the packet transmitted to the network.

When the network interface 314 receives a response with respect to the packet transmitted to the network, the network interface 314 transmits the packet including the received response to the transmission control unit 313.

For example, if the packet that was transmitted to the network previously was a call instruction for moving-picture data, packets having moving-picture data are received in the network interface 314 and the network interface 314 transmits the received packets to the transmission control unit 313.

The transmission control unit 313 converts the public IP address and the port number of the received packets into the private IP address and the port number. Here, the transmission control unit 313 refers to the private IP address and the port number of the first and second devices which were recorded in advance to convert the public IP address into the private IP address.

For example, if the transmission control unit 313 records the private IP address and the port number of the first device 310 and the second device 320 as 198.126.10.3.101 and 198.126.10.3.202, respectively, and the public IP address and the port number recorded on the header of the packet received from the network interface is 221.100.10.1.1009 and 221.100.10.1.2017, respectively, 221.100.10.1.1009 and 221.100.10.1.2017 are converted into 198.126.10.3.101 and 198.126.10.3.202, respectively.

As such, the packets having the header that is converted into the private IP address and the port number are transmitted to the protocol unit 312 of the first device 310 or the second device 320 according to the private IP address and the port number using the TDM. In other words, the packet having the private IP address and the port number of 198.126.10.3.101 is transmitted to the protocol unit 312 of the first device 310 and the packet having the private IP address and the port number of 198.126.10.3.202 is transmitted to the second device 320.

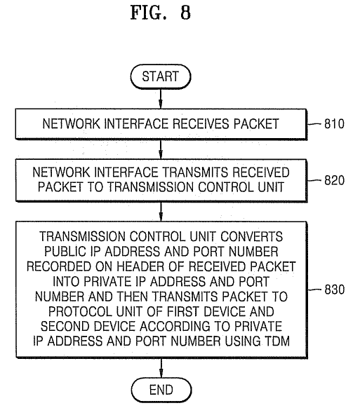

FIG. 8 is a flow chart illustrating a process of receiving a packet from a network using a first device operable in a network resource sharing mode, according to an example embodiment of the present invention.

In operation 810, the network interface 314 receives a packet from a network.

In operation 820, the network interface 314 transmits the received packet to the transmission control unit 313.

In operation 830, the transmission control unit 313 converts a public IP address and a port number recorded on the header of the received packet into a private IP address and a port number, and then transmits the packet to the protocol unit 312 of the first device 310 and the second device 320 according to the private IP address and the port number using the TDM.

When the first device 310 and the second device 320 share the network resource as described above, a user can use a wireless broadband network service using mobile terminals such as mobile phones and PDAs outside. Then, when the user comes back home and connects the mobile terminal with a device that is not connected with the network, the user can use the internet service from the device that is connected with the mobile terminal while telephoning using the terminal or using the network service.

Various components of the network resource sharing apparatus, such as the mode determining unit 210 and the transmission control unit 220, as shown in FIG. 2, or the application unit 311, the protocol unit 312 and the transmission control unit 313, as shown in FIG. 3, can be implemented in software or hardware, such as, for example, an application specific integrated circuit (ASIC) or printed circuit board (PCB). As such, it is intended that the processes described herein be broadly interpreted as being equivalently performed by software, hardware, or a combination thereof. Software modules can be written, via a variety of software languages, including C, C++, Java, Visual Basic, and many others. The various software modules may also be integrated in a single application executed on various types of wireless cards. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

The embodiments of the present invention, shown in FIG. 4, FIG. 7 and FIG. 8, can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

In the present invention, without additional installation of hardware, the network resource can be shared by the first device that is directly connected with the network and the second device that is not connected with the network through software. The present invention is applicable for use with all types of wireless communication devices and wireless networks, including, for example, wireless personal area networks (PANs), wireless local area networks (LANs) such as Wi-Fi networks, Bluetooth, ultra-wideband networks, and wireless metropolitan area networks (MANs) and compatible wireless application protocols usable for wireless transmission as specified by IEEE 802.11(a), (b) and/or (g) standards, Bluetooth standards, other emerging wireless technologies such as Wi-Max or WiBro, or even mobile cellular networks supporting a wide range of coverage.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A method of sharing network resources through a wire/wireless interface between a first device and a second device, in which the first device is connected with a wireless broadband network and the second device is not connected with the wireless broadband network, the method comprising:
making a determination of whether the network resources are to be shared between the first device and the second device; and
selectively routing packets transmitted between the network and the second device based on the determination.

2. The method of claim 1, wherein the routing is performed using a Time Division Multiplexer (TDM), when the network resources are to be shared between the first device and the second device.

3. The method of claim 1, wherein the routing is performed based on an IP address and a port number of a header inserted into packets, when the network resources are to be shared between the first device and the second device.

4. The method of claim 1, wherein the routing is continuously performed on packets, when the network resources are dedicated to the second device.

5. The method of claim 1, wherein the routing is performed by predetermined software installed in the first device.

6. An apparatus for sharing a network resource with a device that is not connected to a network, the apparatus comprising:
a mode determination unit which determines an operation mode according to whether the network resource is to be shared; and
a transmission control unit which selectively routes packets transmitted between the network and the device that is not connected to the network, based on the determined operation mode.

7. The apparatus of claim 6, wherein the transmission control unit routes the packets using a Time Division Multiplexer (TDM), when the operation mode represents a network resource sharing mode for sharing the network resource with the device that is not connected to the network.

8. The apparatus of claim 6, wherein the transmission control unit routes the packets based on an IP address and a port number of a header inserted into the packets, when the operation mode represents a network resource sharing mode for sharing the network resource with the device that is not connected to the network.

9. The apparatus of claim 6, wherein the transmission control unit continuously routes the packets, when the operation mode represents a network resource dedicated mode for dedicating the network resource to the device that is not connected to the network.

10. A computer readable medium having embodied thereon a computer program, which, when executed by a first device connected to a network, performs a method comprising:
making a determination of whether network resources are to be shared with a second device that is connected to the first device, but is not connected to the network; and
selectively routing packets transmitted between the network and the second device based on the determination.

11. The computer readable medium of claim 10, wherein the routing is performed using a Time Division Multiplexer (TDM), when the network resources are to be shared between the first device and the second device.

12. The computer readable medium of claim 10, wherein the routing is performed based on an IP address and a port number of a header inserted into packets, when the network resources are to be shared between the first device and the second device.

13. The computer readable medium of claim 10, wherein the routing is continuously performed on packets, when the network resources are dedicated solely to the second device.

14. A device comprising:
a network interface provided to interface with a network;
an IO interface provided to interface with another device that is not connected to the network; and
a network resource sharing module configured to determine whether network resources are to be shared with said another device that is connected thereto, via the IO interface, but is not connected to the network, and to selectively route packets transmitted between the network and said another device based on the determination.

15. The device of claim 14, wherein the routing is performed using a Time Division Multiplexer (TDM), when the network resources are to be shared with said another device.

16. The device of claim 14, wherein the routing is performed based on an IP address and a port number of a header inserted into packets, when the network resources are to be shared with said another device.

17. The device of claim 14, wherein the routing is continuously performed on packets, when the network resources are dedicated solely to said another device.

18. The device of claim 14, wherein the network resource sharing module comprises:
a user interface to generate packets upon receipt of an order from a user;
a protocol unit arranged to insert a header on which a private IP address and a port number are recorded, into each packet; and
a transmission control unit arranged to convert the private IP address in the header of each packet from the protocol unit into a public IP address, and transmit each packet having the public IP address and the port numbered recorded therein to the network, via the network interface.

19. The device of claim 18, wherein the transmission control unit is further configured to convert, upon receipt packets from the network, the public IP address recorded in the header of each packet into the private IP address, and to transmit each packet having the private IP address and the port numbered recorded therein according to the private IP address and the port number, via a time division multiplexer (TDM).

20. The device of claim 18, wherein the transmission control unit operates in a dedicated mode in which the network resources are used solely by said another device and a network resource sharing mode in which the network resources are shared with said another device.

21. The device of claim 18, wherein the network is a wireless broadband network, and said another device is a user computer connected to the device, via the IO interface.
